(19) United States
(12) Patent Application Publication
(10) Pub. No.: US 2025/0018853 A1
(43) Pub. Date: Jan. 16, 2025

(54) AUGER AND CORE BIT TRAILER

(71) Applicant: White's Welding, LLC, Woodward, OK (US)

(72) Inventors: Alexander L. Marks, Edmond, OK (US); Russell Thompson, Woodward, OK (US)

(21) Appl. No.: 18/770,350

(22) Filed: Jul. 11, 2024

Related U.S. Application Data
(60) Provisional application No. 63/525,981, filed on Jul. 11, 2023.
(60) Provisional application No. 63/545,396, filed on Oct. 24, 2023.

(51) Int. Cl. B60P 7/08; B62D 33/02

(52) U.S. Cl. CPC B60P 7/0823; B60P 7/0807; B62D 33/0207

(57) ABSTRACT

An auger or core bit trailer. The trailer includes a base portion and a support apparatus for securing an auger or core bit to the trailer. The support apparatus includes a stabilizer plate for engaging a part of the auger or core bit and a tension apparatus that engages the stabilizer plate to secure the auger or core bit to the trailer. A method of transporting augers or core bits on a trailer includes securing a core bit or an auger on a trailer. The trailer includes a base portion and a support apparatus for securing the auger or core bit to the trailer. The method also includes transporting the auger or core bit with the trailer.

### CROSS-REFERENCE TO RELATED APPLICATIONS

The present application is a conversion of U.S. Provisional Application having U.S. Ser. No. 63/545,396, filed Oct. 24, 2023, and U.S. Provisional Application having U.S. Ser. No. 63/525,981, filed Jul. 11, 2023, which claim the benefit under 35 U.S.C. 119(e). The disclosures of which are hereby expressly incorporated herein by reference.

### STATEMENT REGARDING FEDERALLY SPONSORED RESEARCH OR DEVELOPMENT

Not applicable.

### BACKGROUND OF THE DISCLOSURE

### 1. Field of the Invention

The present disclosure relates to a trailer for transporting large augers and core bits.

### 2. Description of the Related Art

Certain augers and core bits can be very large and transporting them can be challenging due to their awkward shape and size. Typically, they are laid on their side, which permits them to roll when not secured and potentially damage the blades or flighting of the auger, or damage the sides of the core bits.

Accordingly, there is a need for trailer that can efficiently and safely transport large augers and core bits.

### SUMMARY OF THE DISCLOSURE

The present disclosure is directed to an auger or core bit trailer. The trailer includes a base portion and a support apparatus for securing an auger or core bit to the trailer. The support apparatus includes a stabilizer plate for engaging a part of the auger or core bit and a tension apparatus that engages the stabilizer plate to secure the auger or core bit to the trailer.

The present disclosure is also directed to a method of transporting augers or core bits on a trailer. The method includes securing a core bit or an auger on a trailer. The trailer includes a base portion and a support apparatus for securing the auger or core bit to the trailer. The method also includes transporting the auger or core bit with the trailer.

### BRIEF DESCRIPTION OF THE DRAWINGS

FIG. 1A is a perspective view of an auger and core bit trailer constructed in accordance with the present disclosure.

FIG. 1B is a perspective view of an auger trailer constructed in accordance with the present disclosure.

FIG. 1C is a perspective view of a part of the auger and core bit trailer constructed in accordance with the present disclosure.

FIGS. 2A-2C are perspective views of a part of the auger trailer constructed in accordance with the present disclosure.

FIG. 3 is a perspective view of another part of the auger and core bit trailer constructed in accordance with the present disclosure.

FIG. 4 is a perspective view of another part of the auger and core bit trailer constructed in accordance with the present disclosure.

FIGS. 5A and 5B are perspective views of a part of one embodiment of the auger and core bit trailer constructed in accordance with the present disclosure.

FIGS. 6A and 6B are perspective views of a part of another embodiment of the auger and core bit trailer constructed in accordance with the present disclosure.

### DETAILED DESCRIPTION OF THE DISCLOSURE

The present disclosure is related to an auger and core bit trailer 10 for hauling and transporting augers 12 and core bits 14. Augers 12 typically have a tip 16 that initially encounters the area where an auger 12 is used to dig into the ground, a shaft 18 and flighting 20 or blades disposed on the shaft 18 to cut into the ground and create a hole with the desired diameter. Augers 12 can also include a spur 22 (or spurs, depending upon the design of the auger 12), which are on the leading end 24 of the flighting 20 or blades and starts to expand the size of the hole from the pilot hole caused by the tip 16 of the auger 12. In certain cases, augers 12 have an attachment end 26 for connecting the auger 12 to the machine that is driving the auger 12. The attachment end 26 can include a hollowed out portion 28 for receiving the part of the auger driving machine the auger 12 attaches to.

To support the augers 12 and core bits 14, the trailer 10 can include a support apparatus 30 for being able to secure an auger 12 or core bit 14 to a base 32 of the trailer 10. The trailer 10 can also include wheels 34, fenders 36, a trailer neck 38 and any other typical components of trailers 10. The trailer 10 can include multiple sets of support apparatuses 30 to accommodate multiple augers 12 and core bits 14. Due to the unique shapes of augers 12 and core bits 14, the base 32 of the trailer 10 includes strategically placed openings 40 to accommodate parts of the augers 12 and core bits 14.

The base portion 32 of the trailer 10 can include a tip opening 40a for receiving a part of the tip 16 of the auger 12 and a spur opening 40b to allow a space for the spur(s) 22 of the augers 12 to be without contacting the base portion 32 and potentially damaging the spur(s) 22 of each auger 12. The tip opening 40a can have any shape and size such that a portion of the tip 16 of the auger 12 can be seated on a rim 42 of the tip opening 40a and the spur 22 and flighting 20 of the auger 12 do not contact the rim 42 of the tip opening 40a. Similarly, the spur opening 40b can be any shape and size such that the spur 22 and flighting 20 of the auger 12 do not contact any part of the base 32 of the trailer 10. In one embodiment, the base 32 of the trailer 10 can have separate spur openings 40b for each auger 12 the trailer 10 is transporting. In another embodiment, the base 32 of the trailer 10 can include a single opening (slot) 40b in the base 32 of the trailer 10 that accommodates the spurs 22 of all the augers 12 the trailer 10 is transporting.

Each support apparatus 30 of the trailer 10 can include at least two support posts 44 extending upward from the base portion 32 that are positioned adjacent to the flighting 20 of the auger 12 when the auger 12 is secured to the trailer 10, a stabilizer plate 46 for engaging the attachment end 26 of the auger 12 when the auger 12 is secured to the trailer 10, and a tension apparatus 48 for engaging the stabilizer plate 46 and a part of the trailer 10 to secure the auger 12 to the trailer 10. Each support post 44 can be securely engaged with a portion of the trailer 10 on a lower end 50 of the support post 44 and have an engagement area 52 on/in an upper end 54 of the support post 44. The engagement area 52 is the area of the support post 44 that interacts with the tension apparatus 48. The engagement area 52 could be a channel 56 disposed in the upper end 54 of the support post 44 or it could be a hole disposed through the upper end 54 of the support post 44. In a further embodiment, each engagement area 52 can be rounded to allow for a smoother interaction with the tension apparatus 48. It should be appreciated that the trailer 10 can include any number of support posts 44 desirable to secure the auger 12 to the trailer 10. For example, each support apparatus 30 could include 3, 4 or more support posts 44.

Each support post 44 could be secured direction to a portion of the trailer 10, such as the base portion 32. In another embodiment, the trailer 10 could include a cup portion 58 that corresponds to each support post 44 that each support post 44 could be selectively secured (such as via nuts and bolts) into the cup portion 58. Using a cup portion 58 for the support posts 44 allows for different lengths of support posts 44 to be used depending upon the length of the auger 12 being secured to the trailer 10.

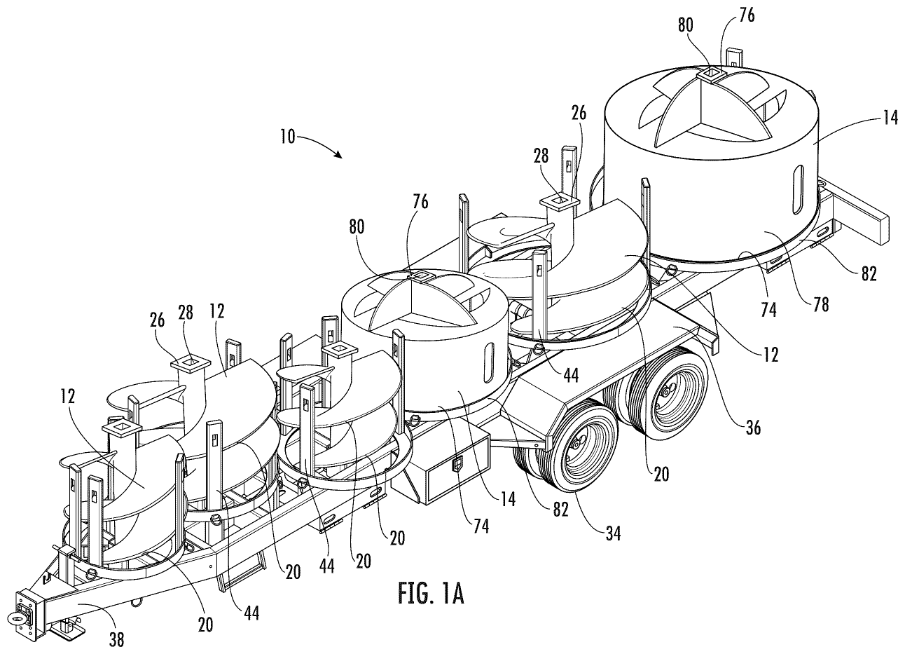

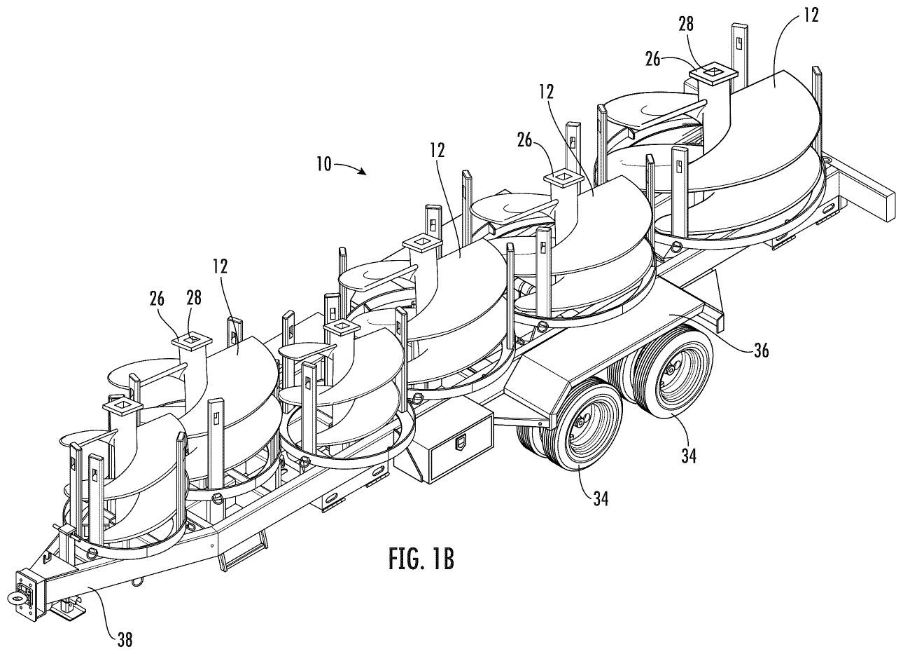

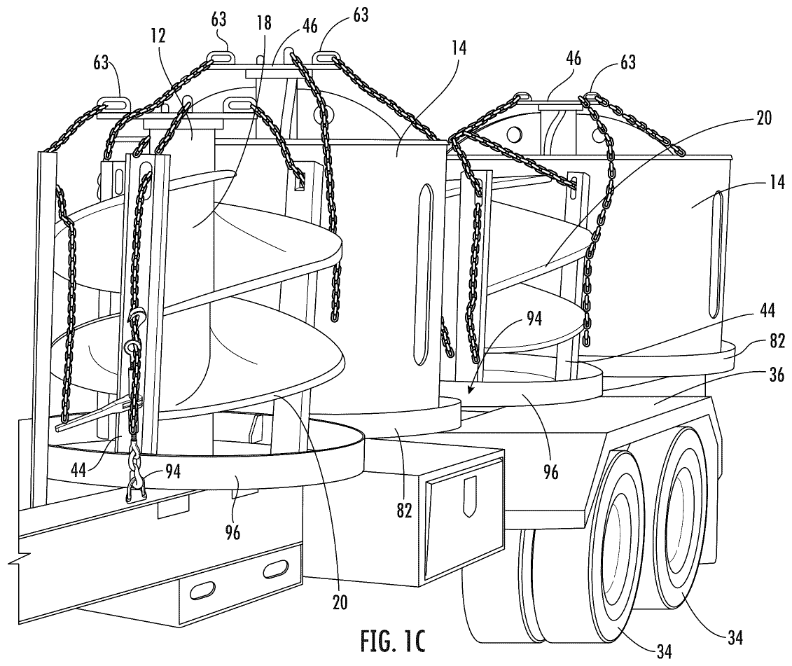

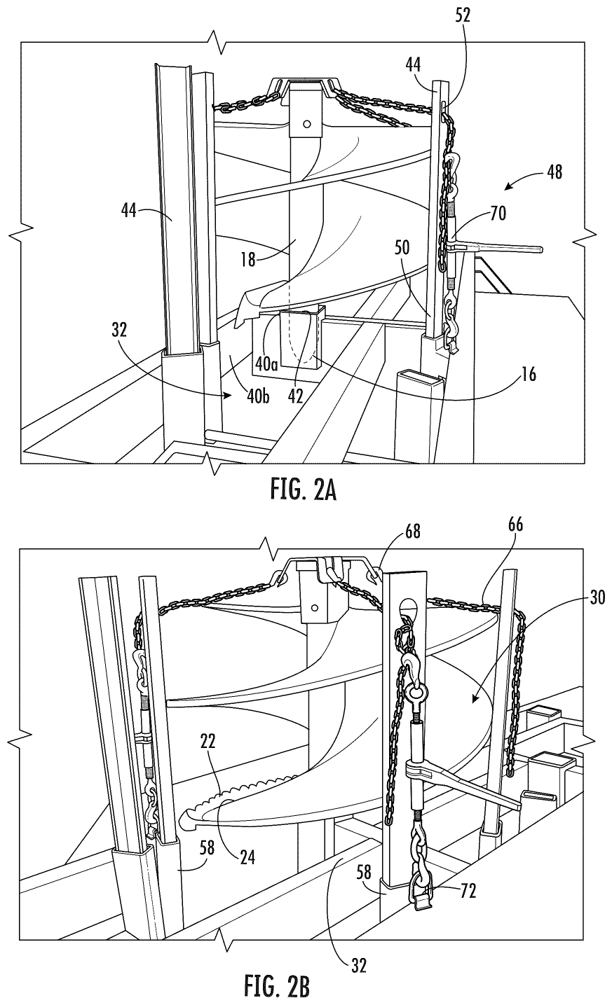

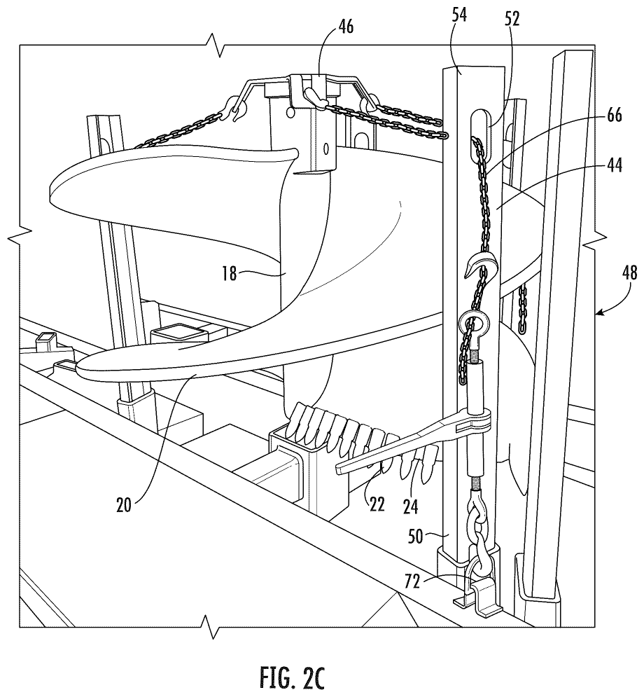

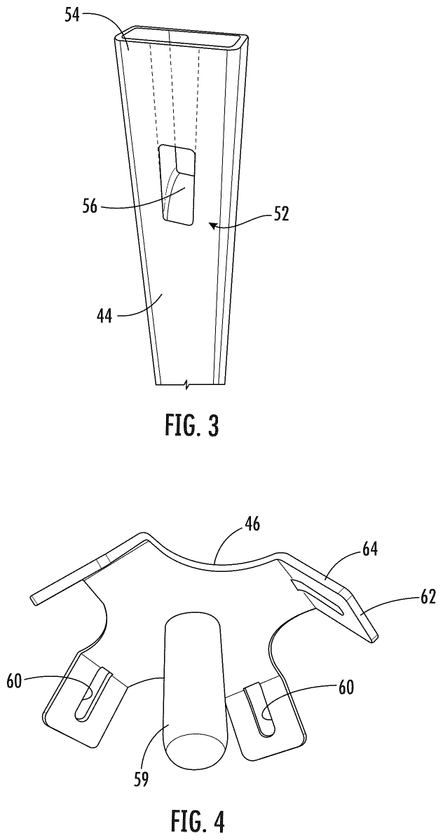

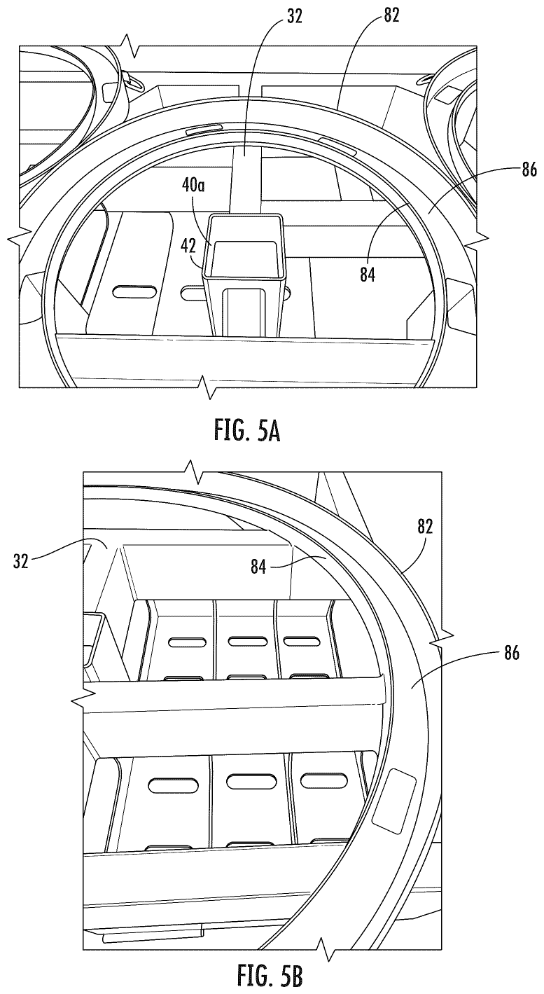

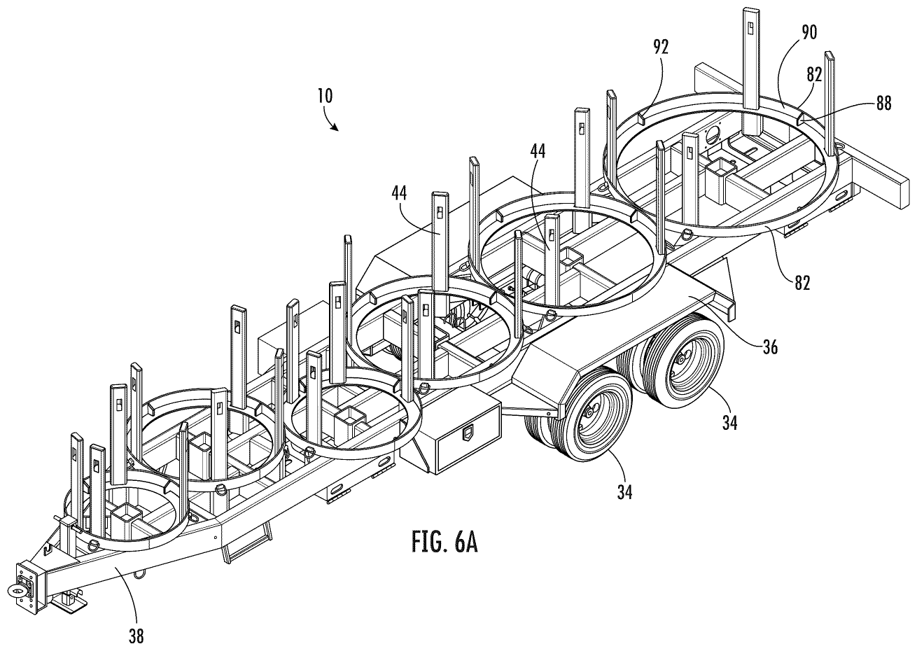

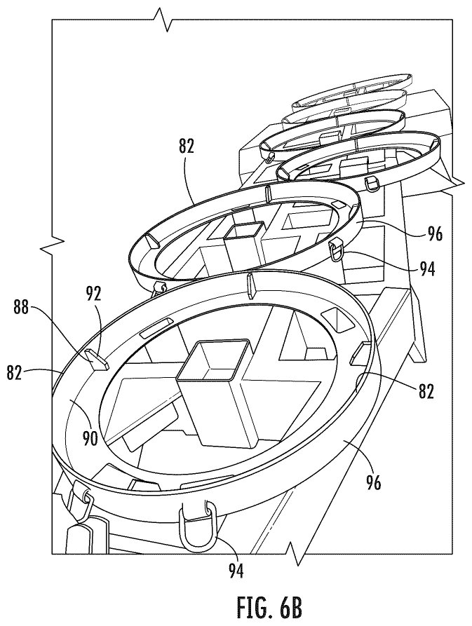

In one embodiment shown in FIGS. 2A-2C and FIG. 4, each stabilizer plate 46 can include a rod portion 59 extending therefrom to extend into the hollowed out portion 28 of the attachment end 26 of the auger 12 and at least two openings 60 in an outer portion 62 of the stabilizer plate 46 for engagement with a part of the tension apparatus 48. Each opening 60 in the outer portion 62 of the stabilizer plate 46 corresponds with a support post 44. Thus, if you have four support posts 44 used to secure the auger 12, the stabilizer plate 46 would have 4 openings 60 in the outer portion 62 of the stabilizer plate 46. In a further embodiment, each opening 60 in the outer portion 62 of the stabilizer plate 46 could be in a flange portion 64 that extends at least partially downward from the stabilizer plate 46. In another embodiment shown in FIG. 1C, the stabilizer plate 46 can include ring members 63 disposed on the outer parts 62 of the stabilizer plate 46. The ring members 63 can be engaged by the tension apparatus 48 similarly to the openings 60 in the other embodiment.

The tension apparatus 48 can be any device or combination of devices that can engage the openings 60 in the stabilizer plate 46, interact with the engagement areas 52 of the upper end 54 of the support posts 44 and can be attached to the trailer 10 when the auger 12 is secured to the trailer 10. In one embodiment, each tension apparatus 48 can include a tension link 66, such as a chain, cable, strap, etc., with an engagement end 68, such as a hook, on one end to engage the corresponding opening 60 in the stabilizer plate 46 and interact with the engagement part 52 of the support post 44 and a tensioning device 70 to engage a part of the tension link 66 and the trailer 10 to apply tension to the chain 66 thereby applying downward force to the auger 12 to secure it in place. Instead of the chain 66, the tension apparatus 48 could also include a cable with a first hook to engage the opening in the stabilizer plate and a second hook to engage the tension device. The tension device 70 can be any device known in the art capable of engaging with a hook or link of chain on one end and a part of the trailer, such as a D-ring 72, on the other end. One example of a tension device 70 is a ratchet load binder.

Core bits 14 typically include a bit end 74 for providing the cutting means for the core bit 14, an attachment end 76 for connecting the auger 12 to the machine that is driving the core bit 14 and a barrel member 78 extending between the bit end 74 and the attachment end 76. Similar to the augers 12, the attachment end 76 of the core bit 14 can include a hollowed out portion 80 for receiving a part of a core bit 14 driving machine the core bit 14 attaches to.

To accommodate the core bits 14, the support apparatuses 30 can include a base portion 82 for supporting each core bit 14 and an outer rim member 82 extending upward from the base portion 32 to prevent lateral movement of the core bit 14 on the trailer 10. In one embodiment of the present disclosure, the support apparatuses 30 can include an inner rim member 84 that cooperates with the outer rim member 82 to create a ring-shaped channel 86 between the two rim members 82 and 84. The ring-shaped channel 86 can receive the bit end 74 of the core bit 14. The inner and outer rims 82 and 84 work together to prevent lateral movement of the core bit 14 on the trailer 10 during transportation of the core bit 14. The rims 82 and 84 can be any height such that proper prevention of lateral movement of the core bits 14 is achieved.

In another embodiment of the present disclosure, the support apparatuses 30 can include gusset plates 88 disposed adjacent and generally perpendicular to the inside 90 of the outer rim member 82. When the core bits 14 are lowered onto the trailer 10 and inside the outer rim member 82, the gusset plates 88 cause the core bits 14 to positioned at a specific location on the trailer 10. Each gusset plate 88 can have an angled side 92 that causes the core bit 14 to be centralized inside the outer rim member 82 when lowered onto the trailer 10 and inside the outer rim member 82. The support apparatuses 30 can include ring elements 94 to be used in securing the core bits 14 to the trailer 10. The ring elements 94 can be secured to the outside 96 of the outer ring members 82 or to any other part of the trailer 10 where the ring elements 94 can be engaged by the tension apparatus 48.

The stabilizer plates 46 described herein can also be used to help secure the core bits 14 to the trailer 10. Therefore, the core bits 14 could be secured using the stabilizer plate 46 and the tension apparatus 48. Similarly, the tension devices 70 used with the augers 12 described herein can be used as part of the tension apparatus 48 used to secure the core bits 14 to the trailer 10.

The present disclosure is also directed to a method of transporting augers 12 and core bits 14 via the trailer 10 disclosed herein. The trailer 10 can transport as many augers 12 and core bits 14 desirable depending on the size of the augers 12 and core bits 14.

From the above description, it is clear that the present disclosure is well-adapted to carry out the objectives and to attain the advantages mentioned herein as well as those inherent in the disclosure. While presently preferred embodiments have been described herein, it will be understood that numerous changes may be made which will readily suggest themselves to those skilled in the art and which are accomplished within the spirit of the disclosure and claims.

What is claimed is:

1. An auger or core bit trailer, the trailer comprising:
a base portion; and
a support apparatus for securing an auger or core bit to the trailer, the support apparatus comprising:
a stabilizer plate for engaging a part of the auger or core bit; and
a tension apparatus that engages the stabilizer plate to secure the auger or core bit to the trailer.

2. The trailer of claim 1 wherein the base portion includes an opening therein to receive a tip of the auger.

3. The trailer of claim 1 wherein the stabilizer plate includes a rod portion extending therefrom for engaging a hollow end of the auger or a hollow end of the core bit.

4. The trailer of claim 1 wherein the stabilizer plate included openings disposed in an outer part of the stabilizer plate or ring elements secured to the outer part of the stabilizer plate, the tension apparatus engageable with the openings or the ring elements.

5. The trailer of claim 1 further comprising support posts supported by the trailer positioned adjacent to the auger.

6. The trailer of claim 5 wherein the support posts include a channel disposed in a top portion or an opening disposed through the top portion that engages the tension apparatus when the auger is secured to the trailer.

7. The trailer of claim 1 wherein the base portion includes an outer rim a bit end of the core bit can extend into to prevent lateral movement of the core bit.

8. The trailer of claim 7 wherein the base portion further comprises an inner rim that creates a channel between the outer rim and the inner rim for receiving the bit end of the core bit to stabilize the core bit on the trailer.

9. The trailer of claim 7 wherein the base portion further includes gusset plates disposed on an inside portion of the outer rim to cause the core bit to be centrally disposed inside the outer rim of the base portion.

10. The trailer of claim 9 wherein each gusset plate has an angled side to help guide the core bit to the desired position within the outer rim.

11. A method of transporting augers or core bits on a trailer, the method comprising:
securing a core bit or an auger on a trailer, the trailer having a base portion and a support apparatus for securing the auger or core bit to the trailer; and
transporting the auger or core bit with the trailer.

12. The method of claim 11 wherein the securing apparatus comprises:
a stabilizer plate for engaging a part of the auger or core bit; and
a tension apparatus that engages the stabilizer plate to secure the auger or core bit to the trailer.

13. The method of claim 12 wherein the base portion includes an opening therein to receive a tip of the auger.

14. The method of claim 12 wherein the stabilizer plate includes a rod portion extending therefrom for engaging a hollow end of the auger or a hollow end of the core bit.

15. The method of claim 12 wherein the stabilizer plate included openings disposed in an outer part of the stabilizer plate or ring elements secured to the outer part of the stabilizer plate, the tension apparatus engageable with the openings or the ring elements.

16. The method of claim 12 further comprising support posts supported by the trailer positioned adjacent to the auger and the support posts include a channel disposed in a top portion or an opening disposed through the top portion that engages the tension apparatus when the auger is secured to the trailer.

17. The method of claim 12 wherein the base portion includes an outer rim a bit end of the core bit can extend into to prevent lateral movement of the core bit.

18. The method of claim 17 wherein the base portion further comprises an inner rim that creates a channel between the outer rim and the inner rim for receiving the bit end of the core bit to stabilize the core bit on the trailer.

19. The method of claim 17 wherein the base portion further includes gusset plates disposed on an inside portion of the outer rim to cause the core bit to be centrally disposed inside the outer rim of the base portion.

20. The method of claim 19 wherein each gusset plate has an angled side to help guide the core bit to the desired position within the outer rim.
